(19) United States
(12) Patent Application Publication
(10) Pub. No.: US 2025/0296712 A1
(43) Pub. Date: Sep. 25, 2025

(54) APPARATUS AND METHOD FOR DETECTING ATTACK ON GYRO SENSOR OF UNMANNED VEHICLE

(71) Applicant: ELECTRONICS AND TELECOMMUNICATIONS RESEARCH INSTITUTE, Daejeon (KR)

(72) Inventors: Sung-Kyung HONG, Seoul (KR); Il-Hwan PARK, Daejeon (KR); Sang-Wook LEE, Daejeon (KR); Seok-Tae LEE, Seoul (KR); Han-Sol JEONG, Seoul (KR)

(21) Appl. No.: 19/079,596

(22) Filed: Mar. 14, 2025

(30) Foreign Application Priority Data
Mar. 19, 2024 (KR) 10-2024-0037891

(51) Int. Cl. B64U 20/80; G06F 21/56

(52) U.S. Cl. CPC B64U 20/80; G06F 21/566; G06F 2221/034

(57) ABSTRACT

Disclosed herein are an apparatus and method for detecting an attack on a gyro sensor of an unmanned vehicle. The apparatus for detecting an attack on a gyro sensor of an unmanned vehicle includes an attack residual generation module configured to generate a residual and a differential of the residual through fusion with sensor-based data, an attack residual evaluation module configured to calculate a value of an attack residual evaluation function for the generated residual and the generated residual differential, and an attack diagnosis module configured to determine whether an attack has been detected by comparing a certain threshold with the function value derived by the attack residual evaluation function.

### CROSS REFERENCE TO RELATED APPLICATION

This application claims the benefit of Korean Patent Application No. 10-2024-0037891, filed Mar. 19, 2024, which is hereby incorporated by reference in its entirety into this application.

### BACKGROUND OF THE INVENTION

### 1. Technical Field

The following embodiments relate to technology for detecting acoustic attacks on the gyro sensor of an unmanned vehicle.

### 2. Description of Related Art

In the case of a multicopter-type unmanned aerial vehicle, commonly referred to as a drone, an Inertial Measurement Unit (IMU) is mounted in the form of an onboard. Such an inertial sensor has recently been implemented in a multiplexing configuration that includes two or three sensors by paying attention to abnormalities in sensors. However, currently, a detection algorithm suitable for multiplexing configuration is not applied depending on the abnormalities. Therefore, there is a need to implement an effective detection algorithm based on a quadcopter in which a single inertial sensor is mounted.

Meanwhile, in an IMU mounted on a drone, a gyro sensor and an accelerometer are essentially mounted as the types of vibrating micro-electromechanical systems (MEMS) sensors. In addition, there is a MEMS IMU in which a geomagnetic sensor is mounted. In particular, a gyro sensor is known to be vulnerable to acoustic attacks in a specific resonant frequency band, which is verified by prior art document 1 (Yunmok, S., Hocheol, S., Dongkwan, K., Youngseok, P., Juhwan, N., Kibum, C., Jungwoo, C. and Yongdae, K. ‘Rocking Drones wth Intentional Sound Noise on Gyroscopic Sensors’, USENIX, 2015, Wasington D.C., pp. 881-896.) and prior art document 2 (Khazaaleh, S., Korres, G., Eid, M., Rasras, M., & Daqaq, M. F. (2019). Vulnerability of MEMS Gyroscopes to Targeted Acoustic Attacks. IEEE Access, 7, 89534-89543.).

Due to acoustic attacks made through a speaker, the gyro sensor clearly influences measurement values. In particular, because methods such as physical isolation, a differential comparator, and resonance tuning disclosed in prior art document 1 may increase cost, and may have physical impacts on a flight control computer, the necessity for development of low-cost software-based defensive measures is disclosed.

Further, prior art document 3 (Cho Hyun-soo, Oh Hee-seok, and Choi Won-seok. (2021), entitled “Method for detecting signal error injection attacks targeting MEMS sensors using vibration signals.” in Information Protection Society papers, 31(3), 411-422.) does not disclose experiments in an environment mounted on dynamic platforms (e.g., drones, unmanned autonomous vehicles, etc.), but discloses signal error injection attacks on IMU (accelerometer+gyro) sensors themselves. Therefore, there is a limitation in that research has not been conducted considering the state of being mounted on the board as in the case of an actual drone. That is, a vibration module used as a technique proposed in prior art document 3 has a limitation in that, during actual drone flight, research in a vibrating environment mixed with the vibration of a driving unit has not been conducted.

Furthermore, prior art document 4 (Hongjun, C., Sayali, K., Yousra, A., Xiangyu, Z. and Dongyan, X. Software-based Realtime Recovery from Sensor Attacks on Robotic Vehicles, RAID, 2020, pp. 349-364.) discloses a sensor attack detection algorithm, and describes that a detection technique based on the difference between a measurement value by a software sensor and an actual measurement value and error correction is used. However, this detection technique may be considerably useful in an initial attack injection stage of a sensor attack, but only the detection technique based on a specific error margin (=fixed threshold) is unsuitable for performance in attack interruption. That is, although the proposed technique has been verified through flight experiments by injecting attacks on gyroscopes in a software environment, attacks have been made through the input of a specific constant value rather than attacks injected by considering acoustic attack aspects for the gyroscope, and thus the verification of an algorithm on the results of experiments in which suitable attack aspects are reflected is required.

Furthermore, prior art document 5 (Tu, Zhan & Fei, Fan & Eagon, Matthew & Zhang, Xiangyu & Xu, Dongyan & Deng, Xinyan. (2018). Redundancy-Free UAV Sensor Fault Isolation and Recovery.) shows that the results of research into detailed examination only for a gyro sensor attack detection algorithm are not verified, thus making it impossible to accurately examine detection performance.

Furthermore, prior art document 6 (Huang S, Liao F, Teo RSH. Fault Tolerant Control of Quadrotor Based on Sensor Fault Diagnosis and Recovery Information. Machines. 2022; 10(11):1088.) shows that a learning process based on a previously trained learning model is required, and quantitative examination for detection performance is not performed. In addition, although research results have been presented on the assumption that bias and multiplication faults in a gyro sensor may occur, description of a fault environment in which bias faults may actually occur is not made.

Furthermore, prior art document 7 (Alkaya, A., & Eker, I. (2014). Luenberger observer-based sensor fault detection: Online application to DC motor. Turkish Journal of Electrical Engineering and Computer Sciences, 22(2), 363-370.) does not describe a suitable detection criterion (threshold setting) and detection performance evaluation for fault detection results.

Furthermore, prior art document 8 (by Eissa, M. A., Darwish, R. R., & Bassiuny, A. M. (2019). Design of Observer-Based Fault Detection Structure for Unknown Systems using Input-Output Measurements: Practical Application to BLDC Drive. Power Electronics and Drives, 4(1), 217-226) shows the results of research focused on fault detection in relation to two fault detection techniques that are compared with each other, and does not describe a suitable detection criterion (threshold setting) and detection performance evaluation for fault detection results.

### SUMMARY OF THE INVENTION

An embodiment is intended to detect an attack on a gyro sensor in an onboard environment, which is mounted on an unmanned vehicle such as a drone.

An embodiment is intended to detect the impact of an acoustic attack on a gyro sensor.

In accordance with an aspect, there is provided an apparatus for detecting an attack on a gyro sensor of an unmanned vehicle, including an attack residual generation module configured to generate a residual and a differential of the residual through fusion with sensor-based data, an attack residual evaluation module configured to calculate a value of an attack residual evaluation function for the generated residual and the generated residual differential, and an attack diagnosis module configured to determine whether an attack has been detected by comparing a certain threshold with the function value derived by the attack residual evaluation function.

The attack residual generation module may be designed based on a Luenberger observer.

The attack residual generation module may be designed for each of rolling motion, pitching motion and yawing motion.

The attack residual generation module may design a system model for rolling motion, as shown in the following Equation (14):

$$\dot{x} ( t ) = Ax ( t ) + Bu ( t ) \qquad ( 14 )$$

$$y ( t ) = Cx ( t )$$

where x(t)=[ϕ,\dot{ϕ}]^{T} and u(t)=[U₂] are satisfied, matrixes A, B, and C of the system model are configured, as shown in the following Equation (15), and U₂ is defined by the following Equation (16):

$$A = [ \begin{matrix}0 & 1 \\ 0 & 0\end{matrix} ] , B = [ \begin{matrix}0 \\ 1 / {I}_{xx}\end{matrix} ] , C = [ \begin{matrix}1 & 0 \\ 0 & 1\end{matrix} ] \qquad ( 15 )$$

$${U}_{2} = \frac{\sqrt{2}}{2} {LK}_{th} ( - {m}_{1} - {m}_{2} + {m}_{3} + {m}_{4} ) \qquad ( 16 )$$

where Kₜₕ is a thrust constant and mᵢ is a control input variable.

The attack residual generation module may design a system model in which an attack on the gyro sensor for rolling motion is taken into consideration, as shown in the following Equation (17):

$$\dot{x} ( t ) = Ax ( t ) + Bu ( t ) \qquad ( 17 )$$

$$y ( t ) = Cx ( t ) + {Df}_{g} ( t )$$

where f_{g}(t) denotes the attack on the gyro sensor, and matrix D of the system model is defined by the following Equation (18):

$$D = [ \begin{matrix}1 & 0 \\ 0 & 1\end{matrix} ] \qquad ( 18 )$$

The attack residual generation module may calculate the residual using the following Equation (19):

$$\dot{\hat{x}} ( t ) = A \hat{x} ( t ) + Bu ( t ) + {L}_{g} ( y ( t ) - \hat{y} ( t ) ) \qquad ( 19 )$$

$$\hat{y} ( t ) = C \hat{x} ( t )$$

$$r ( t ) = y ( t ) - \hat{y} ( t )$$

where \hat{\dot{x}}(t) denotes a state estimation vector for residual generation, L_{g} denotes a gain value matrix of the attack residual generation model, and r(t) denotes a residual vector.

The attack residual evaluation module may use a residual evaluation function shown in the following Equation (20):

$${R}_{i} ( t ) = LPF ( \vert {\vert {r}_{1} ( t ) \vert}^{2} , {\vert {r}_{2} ( t ) \vert}^{2} \vert ) \qquad ( 20 )$$

where LPF denotes a value derived through a low pass filter, and r(t)=[r₁,r₂]^{T} is defined by the following Equation (21):

$${r}_{1} ( t ) = ϕ - \hat{ϕ} , {r}_{2} ( t ) = \dot{ϕ} - \dot{\hat{ϕ}} \qquad ( 21 )$$

The attack diagnosis module may perform diagnosis based on a membership function that receives, as input, a residual and a residual differential value calculated based on a pre-designed residual threshold and a pre-designed residual differential threshold.

In accordance with another aspect, there is provided a method for detecting an attack on a gyro sensor of an unmanned vehicle, including generating a residual and a differential of the residual through fusion with sensor-based data, calculating a value of an attack residual evaluation function for the generated residual and the generated residual differential, and determining whether an attack has been detected by comparing a certain threshold with the function value derived by the attack residual evaluation function.

The generating may be designed based on a Luenberger observer.

The generating may be designed for each of rolling motion, pitching motion and yawing motion.

The generating may include designing a system model for rolling motion, as shown in the following Equation (22):

$$\begin{matrix}\dot{x} ( t ) = Ax ( t ) + Bu ( t ) \\ y ( t ) = Cx ( t )\end{matrix} \qquad ( 22 )$$

where x(t)=[ϕ,\dot{ϕ}]^{T} and u(t)=[U₂] are satisfied, matrixes A, B, and C of the system model are configured, as shown in the following Equation (23), and U₂ is defined by the following Equation (24):

$$A = [ \begin{matrix}0 & 1 \\ 0 & 0\end{matrix} ] , B = [ \begin{matrix}0 \\ 1 / {I}_{xx}\end{matrix} ] , C = [ \begin{matrix}1 & 0 \\ 0 & 1\end{matrix} ] \qquad ( 23 )$$

$${U}_{2} = \frac{\sqrt{2}}{2} {LK}_{th} ( - {m}_{1} - {m}_{2} + {m}_{3} + {m}_{4} ) \qquad ( 24 )$$

where Kₜₕ is a thrust constant and mᵢ is a control input variable.

The generating may further include designing a system model in which an attack on the gyro sensor for rolling motion is taken into consideration, as shown in the following Equation (25):

$$\begin{matrix}\dot{x} ( t ) = Ax ( t ) + Bu ( t ) \\ y ( t ) = Cx ( t ) + {Df}_{g} ( t )\end{matrix} \qquad ( 25 )$$

where f_{g}(t) denotes the attack on the gyro sensor, and matrix D of the system model is defined by the following Equation (26):

$$D = [ \begin{matrix}1 & 0 \\ 0 & 1\end{matrix} ] \qquad ( 26 )$$

The generating may further include calculating the residual using the following Equation (27):

$$\begin{matrix}\dot{\hat{x}} ( t ) = A \hat{x} ( t ) + Bu ( t ) + {L}_{g} ( y ( t ) - \hat{y} ( t ) ) \\ \hat{y} ( t ) = C \hat{x} ( t ) \\ r ( t ) = y ( t ) - \hat{y} ( t )\end{matrix} \qquad ( 27 )$$

where \hat{\dot{x}}(t) denotes a state estimation vector for residual generation, L_{g} denotes a gain value matrix of the attack residual generation model, and r(t) denotes a residual vector.

The calculating may be performed using a residual evaluation function shown in the following Equation (28):

$${{R}_{i} ( t ) = LPF ( ‖ {r}_{1} ( t ) \vert}^{2} , {\vert {r}_{2} ( t ) \vert}^{2} \vert ) \qquad ( 28 )$$

where LPF denotes a value derived through a low pass filter, and r(t)=[r₁,r₂]^{T} is defined by the following Equation (29):

$${r}_{1} ( t ) = ϕ - \hat{ϕ} , {r}_{2} ( t ) = \hat{ϕ} - \dot{\hat{ϕ}} \qquad ( 29 )$$

The determining may include performing diagnosis based on a membership function that receives, as input, a residual and a residual differential value calculated based on a pre-designed residual threshold and a pre-designed residual differential threshold.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a schematic internal block configuration diagram of an unmanned vehicle to which an embodiment is applied;

FIGS. 2 and 3 are diagrams illustrating examples of a drone platform for verifying a method for detecting an attack on a gyro sensor of an unmanned vehicle according to an embodiment;

FIG. 4 is a diagram illustrating an example of an acoustic attack injection test environment to which an embodiment is to be applied;

FIG. 5 is a diagram illustrating an example of a dynamic test bed for measuring the impact of an acoustic attack;

FIG. 6 is a diagram illustrating an example of a test result graph;

FIG. 7 is a diagram illustrating an example of an experiment environment through a directional ultrasonic speaker to which an embodiment is to be applied;

FIG. 8 is a diagram illustrating an example of a test result graph;

FIG. 9 is a schematic block configuration diagram of an apparatus for detecting an attack on a gyro sensor of an unmanned vehicle according to an embodiment;

FIG. 10 is a graph illustrating an example of an alarm signal and a residual generated during hovering flight;

FIG. 11 is a diagram illustrating examples of attitude and angular velocity results during hovering flight;

FIG. 12 is a graph illustrating an example of an attack injection value for Gyro.x;

FIG. 13 is a graph illustrating an example of an alarm signal and a residual generated during an attack;

FIG. 14 is a diagram illustrating examples of attitude and angular velocity results during an attack;

FIG. 15 is a graph illustrating an example of an attack injection value for Gyro.x;

FIG. 16 is a graph illustrating an example of an alarm signal and a residual generated during an attack;

FIG. 17 is a graph illustrating examples of attitude and angular velocity results during an attack;

FIG. 18 is a flowchart for explaining a method for detecting an attack on a gyro sensor of an unmanned vehicle according to an embodiment; and

FIG. 19 is a diagram illustrating the configuration of a computer system according to an example.

### DESCRIPTION OF THE PREFERRED EMBODIMENTS

Advantages and features of the present disclosure and methods for achieving the same will be clarified with reference to embodiments described later in detail together with the accompanying drawings. However, the present disclosure is capable of being implemented in various forms, and is not limited to the embodiments described later, and these embodiments are provided so that this disclosure will be thorough and complete and will fully convey the scope of the present disclosure to those skilled in the art. The present disclosure should be defined by the scope of the accompanying claims. The same reference numerals are used to designate the same components throughout the specification.

It will be understood that, although the terms “first” and “second” may be used herein to describe various components, these components are not limited by these terms. These terms are only used to distinguish one component from another component. Therefore, it will be apparent that a first component, which will be described below, may alternatively be a second component without departing from the technical spirit of the present disclosure.

The terms used in the present specification are merely used to describe embodiments, and are not intended to limit the present disclosure. In the present specification, a singular expression includes the plural sense unless a description to the contrary is specifically made in context. It should be understood that the term “comprises” or “comprising” used in the specification implies that a described component or step is not intended to exclude the possibility that one or more other components or steps will be present or added.

Unless differently defined, all terms used in the present specification can be construed as having the same meanings as terms generally understood by those skilled in the art to which the present disclosure pertains. Further, terms defined in generally used dictionaries are not to be interpreted as having ideal or excessively formal meanings unless they are definitely defined in the present specification.

Most unmanned vehicles, such as drones, more accurately determine physical states using multi-sensor measurements so as to provide reliable data due to concerns about the failure of a single sensor. Therefore, through dual sensors or multiple sensors, a controller may recognize the current physical states and environment, and may then control motor signals so as to perform stable and safe flight depending on the result of recognition.

Sensor fusion may improve accuracy and allow faults in certain kinds of sensor subsets, but it is not effective against physical attacks. In the case of sensor fusion based on a weighted average technique, control performance may be significantly degraded due to a single damaged sensor.

Because traditional sensor fusion-based technology (e.g., Extended Kalman Filter: EKF) relies on actual physical sensors including a damaged sensor, it is difficult to handle attacks that damage the same kind of sensors.

In particular, because gyro sensors generally mounted on unmanned vehicles, such as drones, are vibrating MEMS gyro sensors, research results indicating that vibrating gyro sensors are vulnerable to acoustic attacks are disclosed in prior art documents 1 and 2.

That is, prior art document 1 discloses that each mounted gyro sensor typically has a specific resonant frequency range, and also predicts that, if acoustic attack equipment considering the characteristics of sound waves (e.g., a directional ultrasonic speaker, a Long Range Acoustic Device (LRAD), or the like) is implemented along with a tracking system, an attack will be sufficiently possible within an effective distance.

According to reference documents, it may be proven through independent experiments that faults (failures) attributable to acoustic attacks on gyroscopes may damage angular velocity measurements. Values (measurement values) read from the damaged gyroscope may interfere with the entire control loop. The corresponding attack may affect a navigation system to deliver erroneous angular velocity information to a control system, and such erroneous angular velocity information may increase a fatal effect on an angular velocity controller in the attitude control system of the unmanned vehicle such as a typical drone. As a result, an attitude controller and the angular velocity controller in the attitude control system rapidly compensate for motor input so as to reduce such control input errors, thus consequently losing correct control capability. Because an attacked gyro sensor cannot actually provide effective measurement values, the errors are accumulated through repetition of loops.

Therefore, an embodiment is intended to propose a detection system based on a dynamic model of a multicopter unmanned aerial vehicle in order to detect attacks on the gyro sensor, and such a detection system is based on a process of predicting a next physical state when system input and a current state are given.

Further, an embodiment includes in-depth analysis, application, and improvement based on attack injection and stoppage in the case of acoustic attacks on the gyro sensor. Furthermore, the embodiment includes evaluation for a detection system proposed through performance of repetitive experiments for a false alarm.

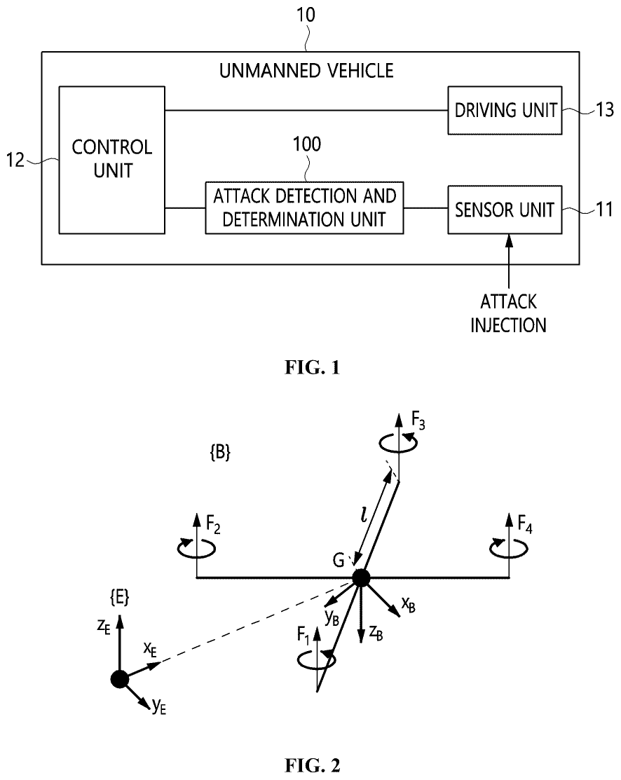

FIG. 1 is a schematic internal block configuration diagram of an unmanned vehicle to which an embodiment is applied.

Referring to FIG. 1, an unmanned vehicle 10 includes a sensor unit 11, a control unit 12, a driving unit 13, and an attack detection and determination unit 100.

The driving unit 13 may include a motor, and may move the unmanned vehicle 10 by rotating a motor in response to a control signal from the control unit 12. In detail, the driving unit 13 may rotate the motor so that the unmanned vehicle 10 is moved in conformity with an acceleration input value selected by the control unit 12. For example, when the unmanned vehicle 10 is an unmanned aerial vehicle (unmanned aircraft), the unmanned vehicle 10 may include at least one propeller, and the motor of the driving unit 13 may be rotated in combination with the at least one propeller. Furthermore, the driving unit 13 may rotate the propeller through the motor based on the control signal from the control unit 12. Therefore, the driving unit 13 may produce a lift force by rotating the propeller through the motor, and may adjust the strength of the lift force by controlling the number of revolutions of the propeller. By adjusting the strength of the lift force, the altitude and acceleration of the unmanned vehicle 10 may be adjusted. In detail, the driving unit 13 may adjust the flight (altitude and acceleration) of the unmanned vehicle 10 under the control of the control unit 12.

Meanwhile, the sensor unit 11 may include at least one sensor for measuring the acceleration value of the unmanned vehicle 10. For example, the sensor unit 11 may include a micro-electro-mechanical system (MEMS) sensor. Here, the MEMS sensor may refer to a system in which mechanical and electronic components are combined with each other in a microstructure on the micrometer scale.

The MEMS sensor may include an acceleration sensor for measuring a movement direction, a movement distance, and velocity related to the linear motion of the unmanned vehicle 10 and a gyroscope sensor for measuring an angular velocity related to the rotational motion of the unmanned vehicle 10. Here, the angular velocity may refer to an angle of rotation per hour (time).

In detail, the sensor unit 11 may obtain acceleration sensing data by measuring movement directions, movement distances, and velocities related to the linear motion of the unmanned vehicle 10 along an X axis (i.e., a transversal axis (width) with respect to the unmanned vehicle 10), a Y axis (i.e., a longitudinal axis (length) with respect to the unmanned vehicle 10) and a Z axis (i.e., a vertical axis (height) with respect to the unmanned vehicle 10) of the unmanned vehicle 10 using the acceleration sensor. Further, the sensor unit 11 may obtain gyro sensing data by measuring angular velocities related to the rotational motion of the unmanned vehicle 10 around the X axis, Y axis, and Z axis of the unmanned vehicle 10 using the gyroscope sensor. The sensor unit 11 may obtain the acceleration measurement value of the unmanned vehicle 10 based on the acceleration sensing data and the gyro sensing data. Here, the acceleration measurement value may include acceleration values measured with respect to the three axes (i.e., X axis, Y axis, and Z axis) of the unmanned vehicle 10, respectively.

Meanwhile, the control unit 12 may typically control the overall operation of the unmanned vehicle 10. The control unit 12 may process signals, data, information, etc. that are input to or output through the components included in the unmanned vehicle 10. For example, the control unit 12 may control the driving unit 13 and the sensor unit 11 by processing the input information.

Meanwhile, the attack detection and determination unit 100 according to an embodiment may perform an operation of detecting an attack on the sensor unit 11 of the unmanned vehicle 10 according to some embodiments of the present disclosure by reading a computer program stored in memory.

The attack detection and determination unit 100 may perform a method for detecting an attack on the gyro sensor of the unmanned vehicle according to the embodiment, and the detailed configuration and operation thereof will be described later with reference to FIG. 9.

Meanwhile, according to an embodiment, attack modeling is derived through actual acoustic attack injection experiments, and is injected to experiments in a software (S/W) manner and then evaluated.

In order to verify the method for detecting an attack on the gyro sensor according to an embodiment, a gyro sensor attack model selected through attack modeling is injected before the output value of the gyro sensor is provided to a navigation system and a control system in a software manner.

Here, as an experiment platform and a simulation model platform, the Crazyflie 2.1 model from Bitcraze, corresponding to a small-sized multicopter platform, was used. A drone applied to the embodiment may be equipped with a BMI-088 Inertial Measurement Unit (IMU) including a gyroscope and an accelerometer.

### Dynamic Model

Modeling such as for a body dynamic model or an aerodynamic model is required in order to implement a dynamic model-based detection system based on a Crazyflie 2.1 platform.

### η Drone (Quadcopter) Dynamic Model

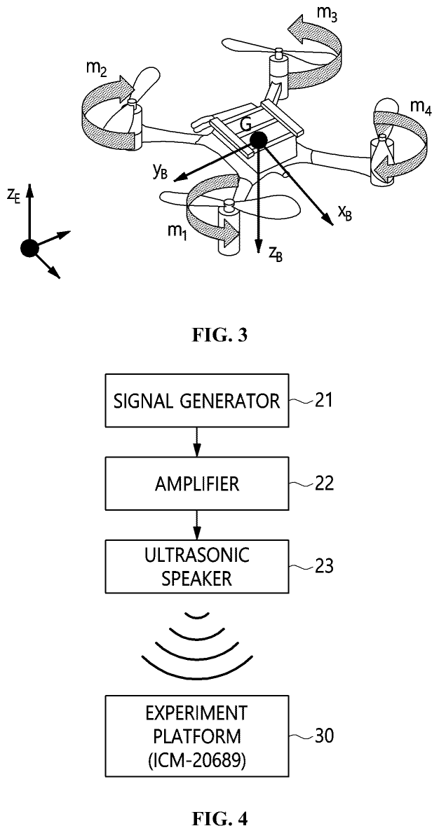

FIGS. 2 and 3 are diagrams illustrating examples of a drone platform for verifying a method for detecting an attack on a gyro sensor of an unmanned vehicle according to an embodiment. This indicates a Crazyflie 2.1 drone multicopter.

Referring to FIG. 2, {E} is the Earth-fixed coordinate system, and {B} is the body-fixed coordinate system. The direction of a configured motor may be illustrated in the drawings, and detailed design variables may be defined as shown in the following Table 1 below.

TABLE 1

| Variable | Value | Unit | Variable | Value | Unit |
|---|---|---|---|---|---|
| Iₓₓ | 3.2132e−5 | kg · m² | g | 9.81 | m/s² |
| I_{yy} | 3.8711e−5 | kg · m² | Kₜₕ | 2.311e−6 | N/PWM_{CF} |
| I_{zz} | 4.8387e−5 | kg · m² | K_{d} | 1.378e−8 | Nm/PWM_{CF} |
| m | 0.038 | kg | L | 0.046 | M |

a. Body Dynamic Model

The body dynamics of a drone (quadcopter) are composed of translational motion, rotational motion, and coordinate system transformation, and may be analyzed mathematically, as shown in the following Equation (1):

$$\{ \begin{matrix}\overline{ϕ} = \frac{{I}_{yy} - {I}_{xx}}{{I}_{xx}} \dot{θ} \dot{ψ} + \frac{1}{{I}_{xx}} {U}_{2} \\ \overline{θ} = \frac{{I}_{xx} - {I}_{xx}}{{I}_{yy}} \dot{ϕ} \dot{ϕ} + \frac{1}{{I}_{yy}} {U}_{3} \\ \overline{ψ} = \frac{{I}_{xx} - {I}_{yy}}{{I}_{xx}} \dot{ϕ} \dot{θ} + \frac{1}{{I}_{zz}} {U}_{4} \\ \overline{x} = - \frac{1}{m} ( cos ϕ sin θcos ψ + sin ϕsin ψ ) {U}_{1} \\ \overline{y} = - \frac{1}{m} ( cos ϕ sin θsin ψ - sin ϕcos ψ ) {U}_{1} \\ \overline{z} = g - \frac{1}{m} ( cos ϕ cos θ ) {U}_{1}\end{matrix} \qquad ( 1 )$$

b. Aerodynamic Model

The drone (quadcopter) is characterized in that an aerodynamic model needs to be taken into consideration. Referring to FIG. 3, mathematical models such as those in the following Equations (2) and (3), may be derived when Newtonian mechanics are applied depending on an embodied motor direction. In this case, the elastic effect of the propeller is ignored.

$$F = ( \begin{matrix}{F}_{x} \\ {F}_{y} \\ {F}_{z}\end{matrix} ) = ( \begin{matrix}0 \\ 0 \\ - {K}_{th} ( {m}_{1} + {m}_{2} + {m}_{3} + {m}_{4} )\end{matrix} ) \qquad ( 2 )$$

$$M = ( \begin{matrix}{M}_{x} \\ {M}_{y} \\ {M}_{z}\end{matrix} ) = ( \begin{matrix}\frac{\sqrt{2}}{2} {LK}_{th} ( - {m}_{1} - {m}_{2} - {m}_{3} - {m}_{4} ) \\ \frac{\sqrt{2}}{2} {LK}_{th} ( + {m}_{1} - {m}_{2} - {m}_{3} + {m}_{4} ) \\ {K}_{d} ( + {m}_{1} - {m}_{2} + {m}_{3} - {m}_{4} )\end{matrix} ) \qquad ( 3 )$$

In Equation 2, thrust Fₓ=Kₜₕmᵢ[N] (i=1,2,3,4) and Mᵢ=K_{d}mᵢ[N·m] (i=1,2,3,4) are applied. Here, Kₜₕ may be a thrust constant, K_{d} may be a drag moment constant, and mᵢ may be a control input variable.

### Examination of Impact of Attack on Gyro Sensor

Case 1: Acoustic Attack Experiment Environment Based on Dynamic Ultrasonic Speaker

Based on independent experiments for an environment to which an embodiment is to be applied, the impact of an acoustic attack on a gyroscope is examined.

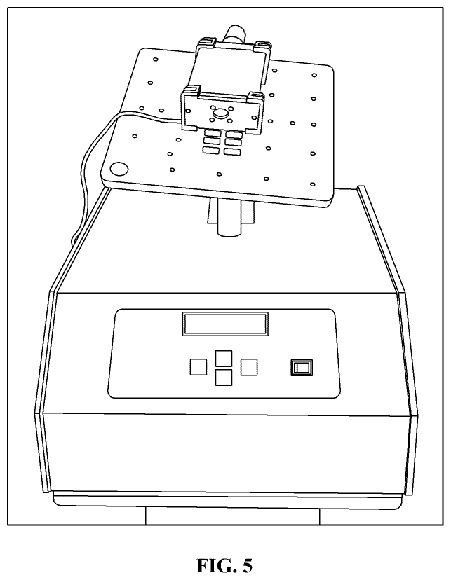

FIG. 4 is a diagram illustrating an example of an acoustic attack injection test environment to which an embodiment is to be applied.

Referring to FIG. 4, an experiment environment is constructed to include a signal generator 21 for generating a signal matching the resonant frequency of a sensor and an amplifier 22 for amplifying the output signal of the signal generator 21 and to emit an amplified signal through a dynamic ultrasonic speaker 23.

Through the above-described experiment environment, an acoustic attack is applied to a flight control computer 30 that is an experiment platform, and the impact of the acoustic attack is examined.

FIG. 5 is a diagram illustrating an example of a dynamic test bed for measuring the impact of an acoustic attack.

Referring to FIG. 5, a dynamic environment test in an environment in which a flight control computer is placed on a rotational motion test bed and is rotated at a fixed angle and a constant speed progresses.

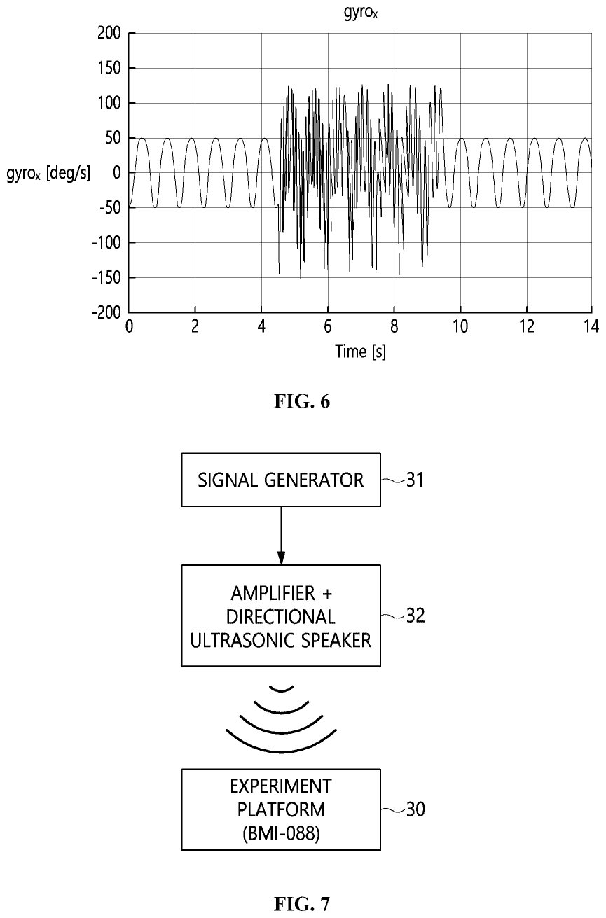

FIG. 6 is a diagram illustrating an example of a test result graph.

Referring to FIG. 6, when an attack is not applied, an angular velocity is maintained at a value falling within a range of −50 to 50 deg/s, whereas, when an attack is applied, the angular velocity exhibits a vibrating tendency in such a way that the sensor value is amplified and is verified as having a value falling within a range of −150to 150 deg/s.
Case 2: Acoustic Attack Experiment Environment Based on Directional Ultrasonic Speaker

FIG. 7 is a diagram illustrating an example of an experiment environment through a directional ultrasonic speaker to which an embodiment is to be applied.

Referring to FIG. 7, the experiment environment is constructed through a directional ultrasonic speaker 32 in which an amplifier and a speaker are combined with each other from a signal generator 31, and an acoustic attack is applied to a flight control computer 30, after which the impact of the acoustic attack is examined.

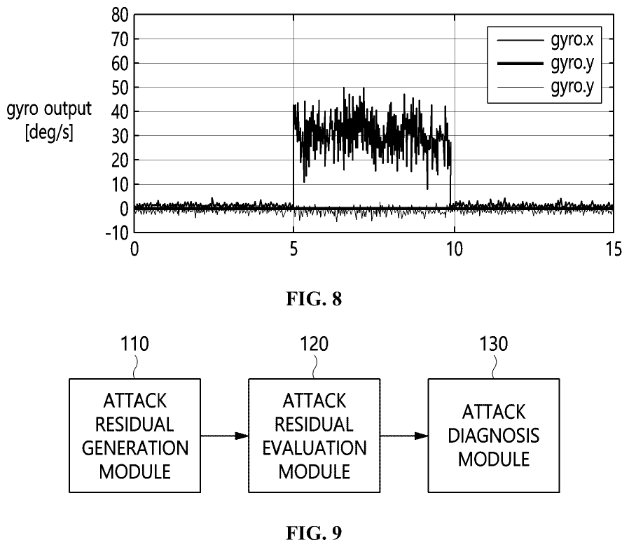

FIG. 8 is a diagram illustrating an example of a test result graph.

Referring to FIG. 8, it can be seen that, unlike a dynamic ultrasonic speaker, the impact of the attack appears in such a way that an offset of a certain value is generated at the same time that sinusoidal noise is added.

As described above, the tendency of an attack impact may vary depending on the type of speaker that applies the acoustic attack, whereby it can be verified that the impact of the acoustic attack cannot be overcome using only an existing filter-based algorithm.

FIG. 9 is a schematic block configuration diagram of an apparatus for detecting an attack on a gyro sensor of an unmanned vehicle according to an embodiment.

Referring to FIG. 9, an apparatus 100 for detecting an attack on the gyro sensor according to the embodiment may include an attack residual generation module 110, an attack residual evaluation module 120, and an attack diagnosis module 130.

The attack residual generation module 110 may generate a residual and a differential (derivative) of the residual through fusion with sensor-based data.

Here, the attack residual generation module is designed based on a Luenberger observer to obtain a residual r and a differential of the residual \dot{r}.

The attack residual evaluation module 120 may calculate the value of an attack residual evaluation function for the obtained residual and the obtained residual differential.

The attack diagnosis module 130 determines whether an attack has been detected by comparing a predetermined threshold Rₜₕ with the function value derived through the attack residual evaluation function.

Here, the attack residual generation module 110 may be designed for each of rolling motion, pitching motion and yawing motion. In accordance with embodiments, an example of rolling motion has been described below. However, the embodiments of the present disclosure are not limited to a rolling motion. That is, in accordance with the embodiment, the attack residual generation module 110 can be applied to rolling motion, pitching motion, and yawing motion.

A system model for the rolling motion may be designed as shown in the following Equation (4), for ϕ,\dot{ϕ} fed back into the angle rate loop of an attitude controller.

$$\begin{matrix}\dot{x} ( t ) = Ax ( t ) + Bu ( t ) \\ y ( t ) = Cx ( t )\end{matrix} \qquad ( 4 )$$

Here, x(t)=[ϕ,\dot{ϕ}]^{T} and u(t)=[U₂] may be satisfied, matrixes A, B, and C of the system model may be configured, as shown in the following Equation (5), and U₂ may be defined by the following Equation (6):

$$A = [ \begin{matrix}0 & 1 \\ 0 & 0\end{matrix} ] , B = [ \begin{matrix}0 \\ 1 / {I}_{xx}\end{matrix} ] , C = [ \begin{matrix}1 & 0 \\ 0 & 1\end{matrix} ] \qquad ( 5 )$$

$${U}_{2} = \frac{\sqrt{2}}{2} {LK}_{th} ( - {m}_{1} - {m}_{2} + {m}_{3} + {m}_{4} ) \qquad ( 6 )$$

Because Equation (5) is the system model for the rolling motion of the drone, and the attack on the sensor is added to y(t) corresponding to the output of the system, the system model considering the sensor attack f_{g}(t) may be defined by the following Equation (7):

$$\begin{matrix}\dot{x} ( t ) = Ax ( t ) + Bu ( t ) \\ y ( t ) = Cx ( t ) + {Df}_{g} ( t )\end{matrix} \qquad ( 7 )$$

In Equation (7), matrix D, which is the component of the system model, may be defined by the following Equation (8), and the sensor attack f_{g}(t) may be defined by the following Equation (9):

$$D = [ \begin{matrix}1 & 0 \\ 0 & 1\end{matrix} ] \qquad ( 8 )$$

$${f}_{g} ( t ) = [ {f}_{ϕ} ] \qquad ( 9 )$$

The attack residual generation module 110 based on the Luenberger observer may be designed, as shown in the following Equation (10):

$$\begin{matrix}\dot{x} ( t ) = A \hat{x} ( t ) + Bu ( t ) + {L}_{g} ( y ( t ) - \hat{y} ( t ) ) \\ y ( t ) = C \hat{x} ( t ) \\ r ( t ) = y ( t ) - \hat{y} ( t )\end{matrix} \qquad ( 10 )$$

In Equation (10), \hat{\dot{x}}(t) may be a state estimation vector for residual generation, L_{g} may be a gain value matrix of the described attack residual generation model, and r(t)=[r₁,r₂]^{T} may be a generated residual vector. The configuration of the above-described system may be designed, as shown in the following Equations (11) and (12):

$${r}_{1} ( t ) = ϕ - \hat{ϕ} , {r}_{2} ( t ) = \dot{ϕ} - \dot{\hat{ϕ}} \qquad ( 11 )$$

$$A = [ \begin{matrix}0 & 1 \\ 0 & 0\end{matrix} ] , B = [ \begin{matrix}0 \\ 1 / {I}_{xx}\end{matrix} ] , C = [ \begin{matrix}1 & 0 \\ 0 & 1\end{matrix} ] , {L}_{g} = [ \begin{matrix}{k}_{L 11} & 0 \\ 0 & {k}_{L 22}\end{matrix} ] \qquad ( 12 )$$

Next, the attack residual evaluation module 120 may use a residual evaluation function such as that shown in the following Equation (13).

$${R}_{i} ( t ) = LPF ( ⌈ {\vert {r}_{1} ( t ) \vert}^{2} , {\vert {r}_{2} ( t ) \vert}^{2} ⌉ ) \qquad ( 13 )$$

In Equation (13), LPF may denote a value derived through a low-pass filter, and r(t)=[r₁,r₂]^{T} may be defined by the above-described Equation (11).

Finally, the attack diagnosis module 130 is designed based on the above-described residual evaluation function value.

Here, the attack diagnosis module 130 may perform diagnosis based on a membership function which receives, as input, the residual and the residual differential value, which are calculated based on a pre-designed residual threshold and a pre-designed residual differential threshold.

### Validity Examination

### <Normal Condition>

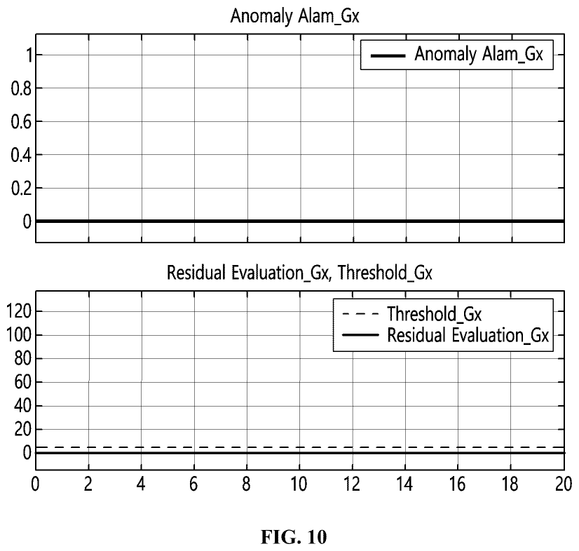

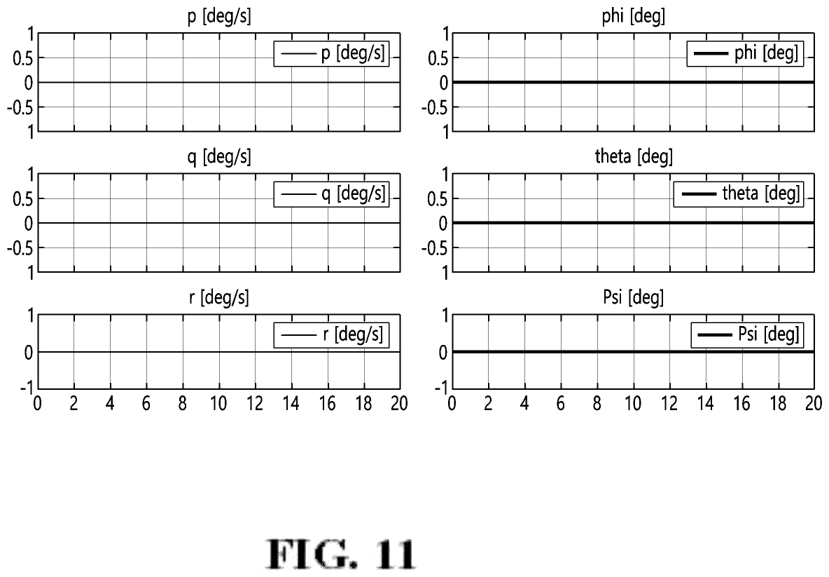

FIG. 10 is a graph illustrating an example of an alarm signal and a residual generated during hovering flight, and FIG. 11 is a diagram illustrating examples of attitude and angular velocity results during hovering flight.

Referring to FIGS. 10 and 11, it is proven that, when hovering flight is performed in a normal condition, the residual is maintained closer to 0, and an alarm does not go off.

### <Attack Condition (Case 1)>

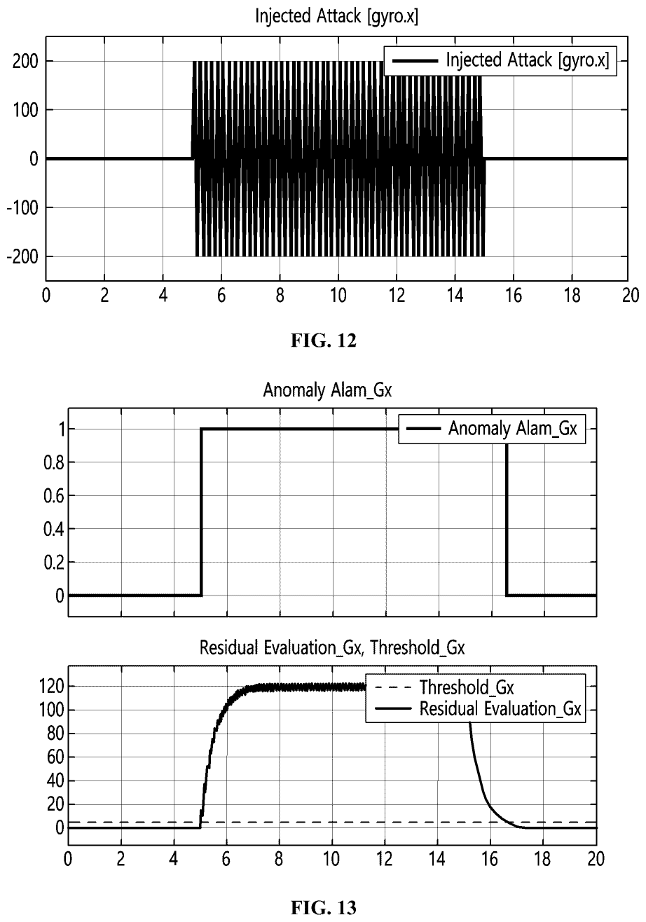

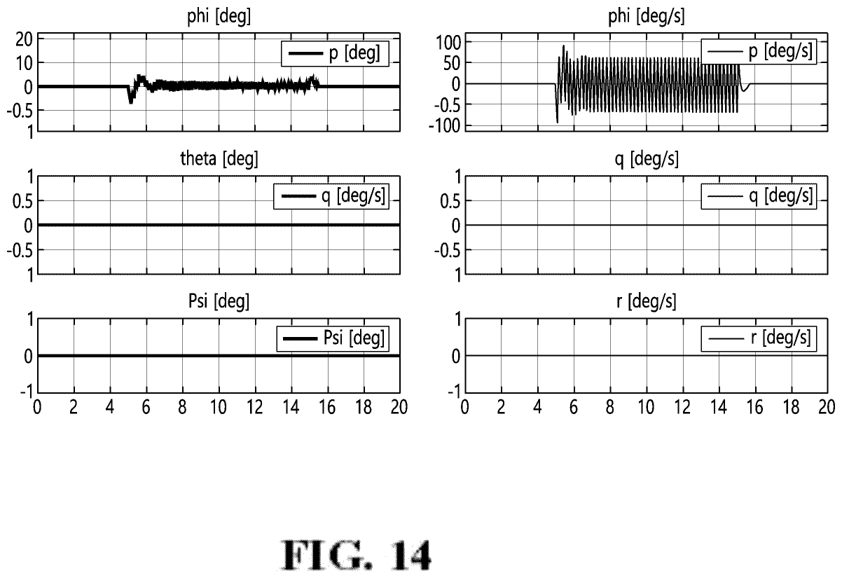

FIG. 12 is a graph illustrating an example of an attack injection value for Gyro.x, FIG. 13 is a graph illustrating examples of an alarm signal and a residual generated during an attack, and FIG. 14 is a graph illustrating examples of attitude and angular velocity results during an attack.

Referring to FIGS. 12 to 14, the case where a sinusoidal time-varying attack is applied to the X axis of a gyro sensor is set. The attack was made for a time period of 5 to 15 seconds. As described above, the detection of the attack was monitored.

### <Attack Condition (Case 2)>

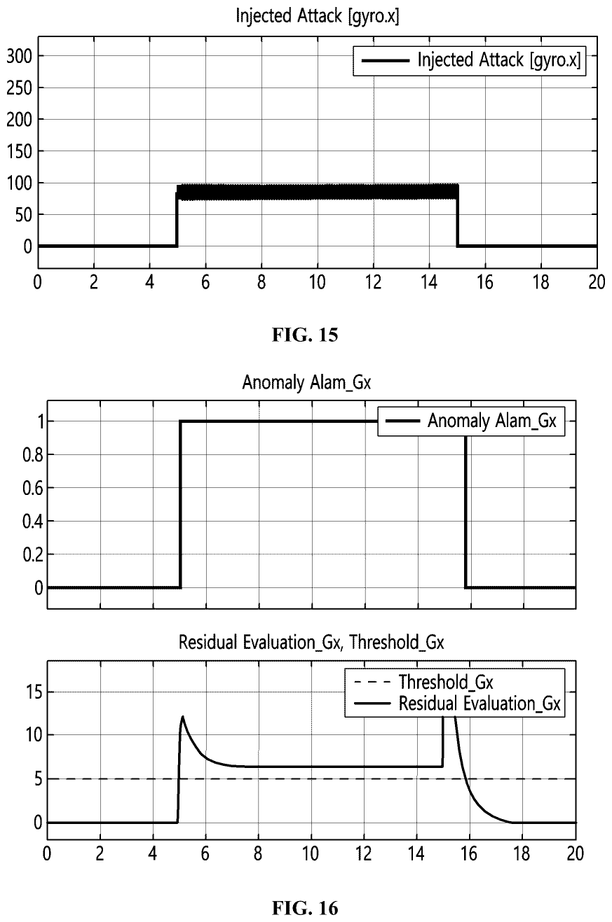

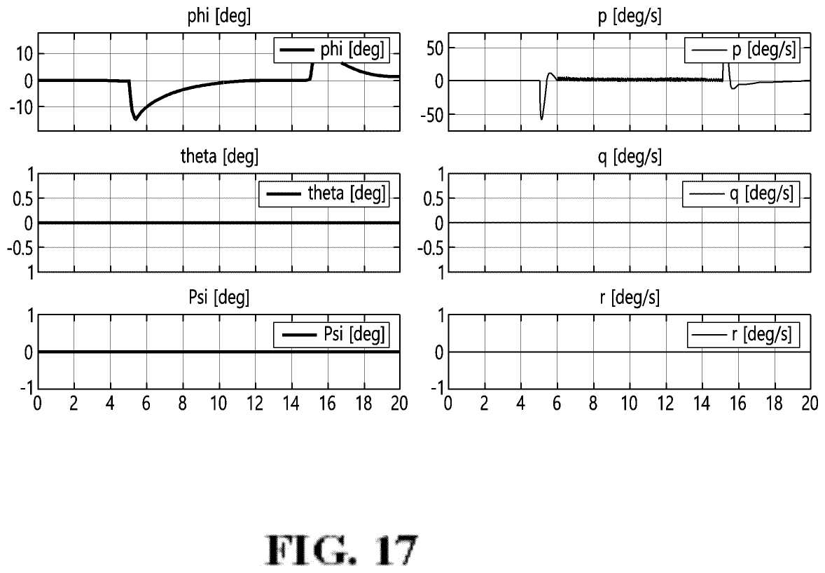

FIG. 15 is a graph illustrating an example of an attack injection value for Gyro.x, FIG. 16 is a graph illustrating an example of an alarm signal and a residual generated during an attack, and FIG. 17 is a graph illustrating examples of attitude and angular velocity results during an attack.

Referring to FIGS. 15 to 17, the case where a sinusoidal time-varying attack is applied at the same time that an offset value is generated on the X axis of the gyro sensor is set. The attack was made for a time period of 5 to 15 seconds.

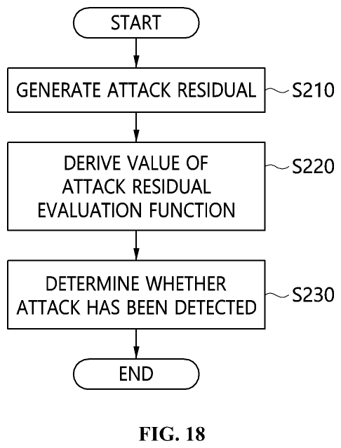

FIG. 18 is a flowchart illustrating a method for detecting an attack on a gyro sensor of an unmanned vehicle according to an embodiment.

Referring to FIG. 18, the method for detecting an attack on the gyro sensor of the unmanned vehicle according to the embodiment may include step S210 of generating a residual and a differential of the residual through fusion with sensor-based data, step S220 of calculating the value of an attack residual evaluation function for the generated residual and the residual differential, and step S230 of determining whether an attack has been detected by comparing a certain threshold with the function value derived by the attack residual evaluation function.

In accordance with the embodiments, by detecting and determining attacks through a non-divergent detection algorithm when acoustic attacks are injected into a vibrational MEMS gyro sensor, this detection method ensures no false alarm against attacks even during the prolonged operation of an unmanned vehicle, thus enhancing the safety and security features of unmanned vehicles.

Further, error-free sensor measurements indicate a critical factor in the flight or driving (movement) of unmanned vehicles, and thus the safety of unmanned vehicles may be guaranteed only when the results of attack detection and determination do not diverge over time without causing a false alarm.

Furthermore, based on the results of attack detection without causing a false alarm, applying an attack recovery function together with an attack detection function may significantly contribute to preventing major incidents that cause life-threatening accidents, such as loss of control and crashes, and other incidents such as property damage.

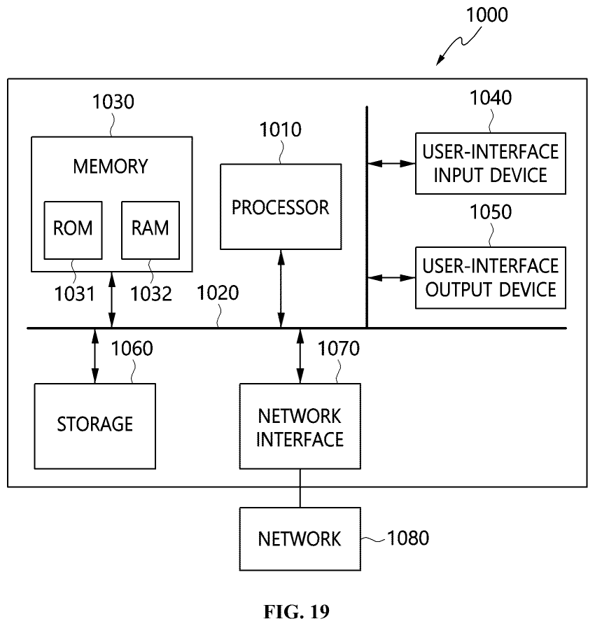

FIG. 19 is a diagram illustrating the configuration of a computer system according to an embodiment.

An apparatus 100 for detecting an attack on a gyro sensor of an unmanned vehicle according to an embodiment may be implemented in a computer system 1000 such as computer-readable storage medium.

The computer system 1000 may include one or more processors 1010, memory 1030, a user interface input device 1040, a user interface output device 1050, and storage 1060, which communicate with each other through a bus 1020. The computer system 1000 may further include a network interface 1070 connected to a network 1080. Each processor 1010 may be a Central Processing Unit (CPU) or a semiconductor device for executing programs or processing instructions stored in the memory 1030 or the storage 1060. Each of the memory 1030 and the storage 1060 may be a storage medium including at least one of a volatile medium, a nonvolatile medium, a removable medium, a non-removable medium, a communication medium or an information delivery medium, or a combination thereof. For example, the memory 1030 may include Read-Only Memory (ROM) 1031 or Random Access Memory (RAM) 1032

In accordance with embodiments, attacks on a gyro sensor in an onboard environment, which is mounted on an unmanned vehicle such as a drone, may be detected.

In accordance with embodiments, the impact of acoustic attacks on a gyro sensor may be detected.

In accordance with embodiments, an example has been described in which the detection of acoustic attacks is applied to a drone equipped with a MEMS sensor. However, the embodiments of the present disclosure are not limited to a drone. That is, in accordance with the embodiment, the detection of acoustic attacks can be applied to various types of unmanned vehicles equipped with a MEMS sensor, such as unmanned ground vehicles (UGVs) and unmanned robotic systems.

Although the embodiments of the present disclosure have been disclosed with reference to the attached drawing, those skilled in the art will appreciate that the present disclosure can be implemented in other concrete forms, without changing the technical spirit or essential features of the disclosure. Therefore, it should be understood that the foregoing embodiments are merely exemplary, rather than restrictive, in all aspects.

What is claimed is:

1. An apparatus for detecting an attack on a gyro sensor of an unmanned vehicle, comprising:
an attack residual generation module configured to generate a residual and a differential of the residual through fusion with sensor-based data;
an attack residual evaluation module configured to calculate a value of an attack residual evaluation function for the generated residual and the generated residual differential; and
an attack diagnosis module configured to determine whether an attack has been detected by comparing a certain threshold with the function value derived by the attack residual evaluation function.

2. The apparatus of claim 1, wherein the attack residual generation module is designed based on a Luenberger observer.

3. The apparatus of claim 1, wherein the attack residual generation module is designed for each of rolling motion, pitching motion and yawing motion.

4. The apparatus of claim 1, wherein the attack residual generation module designs a system model for rolling motion, as shown in the following Equation (14):
$$\begin{matrix}\dot{x} ( t ) = Ax ( t ) + Bu ( t ) \\ y ( t ) = Cx ( t )\end{matrix} \qquad ( 14 )$$
where and x(t)=[ϕ,\dot{ϕ}]^{T} are satisfied, matrixes A, B, and C of the system model are configured, as shown in the following Equation (15), and U₂ is defined by the following Equation (16):
$$A = [ \begin{matrix}0 & 1 \\ 0 & 0\end{matrix} ] , B = [ \begin{matrix}0 \\ 1 / {T}_{xx}\end{matrix} ] , C = [ \begin{matrix}1 & 0 \\ 0 & 1\end{matrix} ] \qquad ( 15 )$$
$${U}_{2} = \frac{\sqrt{2}}{2} {LK}_{th} ( - {m}_{1} - {m}_{2} + {m}_{3} + {m}_{4} ) \qquad ( 16 )$$
where Kₜₕ is a thrust constant and mᵢ is a control input variable.

5. The apparatus of claim 4, wherein the attack residual generation module designs a system model in which an attack on the gyro sensor for rolling motion is taken into consideration, as shown in the following Equation (17):
$$\begin{matrix}\dot{x} ( t ) = Ax ( t ) + Bu ( t ) \\ y ( t ) = Cx ( t ) + {Df}_{g} ( t )\end{matrix} \qquad ( 17 )$$
where fₓ(t) denotes an amount of attack on the gyro sensor, and matrix D of the system model is defined by the following Equation (18):
$$D = [ \begin{matrix}1 & 0 \\ 0 & 1\end{matrix} ] . \qquad ( 18 )$$

6. The apparatus of claim 5, wherein the attack residual generation module calculates the residual using the following Equation (19):
$$\begin{matrix}\dot{\hat{x}} ( t ) = A \hat{x} ( t ) + Bu ( t ) + {L}_{g} ( y ( t ) - \hat{y} ( t ) ) \\ \hat{y} ( t ) = C \hat{x} ( t ) \\ r ( t ) = y ( t ) - \hat{y} ( t )\end{matrix} \qquad ( 19 )$$
where \hat{\dot{x}}(t) denotes a state estimation vector for residual generation, L_{g} denotes a gain value matrix of the attack residual generation model, and r(t) denotes a residual vector.

7. The apparatus of claim 6, wherein the attack residual evaluation module uses a residual evaluation function shown in the following Equation (20):
$${R}_{i} ( t ) = LPF ( ⌈ {\vert {r}_{1} ( t ) \vert}^{2} , {\vert {r}_{2} ( t ) \vert}^{2} ⌉ ) \qquad ( 20 )$$
where LPF denotes a value derived through a low pass filter, and r(t)=[r₁,r₂]^{T} is defined by the following Equation (21):
$${r}_{1} ( t ) = ϕ - \hat{ϕ} , {r}_{2} ( t ) = \dot{ϕ} - \dot{\hat{ϕ}} . \qquad ( 21 )$$

8. The apparatus of claim 7, wherein the attack diagnosis module performs diagnosis based on a membership function that receives, as input, a residual and a residual differential value calculated based on a pre-designed residual threshold and a pre-designed residual differential threshold.

9. A method for detecting an attack on a gyro sensor of an unmanned vehicle, comprising:
generating a residual and a differential of the residual through fusion with sensor-based data;
calculating a value of an attack residual evaluation function for the generated residual and the generated residual differential; and
determining whether an attack has been detected by comparing a certain threshold with the function value derived by the attack residual evaluation function.

10. The method of claim 9, wherein the generating is designed based on a Luenberger observer.

11. The method of claim 9, wherein the generating is designed for each of rolling motion, pitching motion and yawing motion.

12. The method of claim 9, wherein the generating comprises:
designing a system model for rolling motion, as shown in the following Equation (22):
$$\begin{matrix}\dot{x} ( t ) = Ax ( t ) + Bu ( t ) \\ y ( t ) = Cx ( t )\end{matrix} \qquad ( 22 )$$
where and x(t)=[ϕ,\dot{ϕ}]^{T} are satisfied, matrixes A, B, and C of the system model are configured, as shown in the following Equation (23), and U₂ is defined by the following Equation (24):
$$A = [ \begin{matrix}0 & 1 \\ 0 & 0\end{matrix} ] , B = [ \begin{matrix}0 \\ 1 / {T}_{xx}\end{matrix} ] , C = [ \begin{matrix}1 & 0 \\ 0 & 1\end{matrix} ] \qquad ( 23 )$$
$${U}_{2} = \frac{\sqrt{2}}{2} {LK}_{th} ( - {m}_{1} - {m}_{2} + {m}_{3} + {m}_{4} ) \qquad ( 24 )$$
where Kₜₕ is a thrust constant and mᵢ is a control input variable.

13. The method of claim 12, wherein the generating further comprises:
designing a system model in which an attack on the gyro sensor for rolling motion is taken into consideration, as shown in the following Equation (25):
$$\begin{matrix}\dot{x} ( t ) = Ax ( t ) + Bu ( t ) \\ y ( t ) = Cx ( t ) + {Df}_{g} ( t )\end{matrix} \qquad ( 25 )$$
where f_{g}(t) denotes an amount of attack on the gyro sensor, and matrix D of the system model is defined by the following Equation (26):
$$D = [ \begin{matrix}1 & 0 \\ 0 & 1\end{matrix} ] . \qquad ( 26 )$$

14. The method of claim 13, wherein the generating further comprises:
calculating the residual using the following Equation (27):
$$\begin{matrix}\dot{\hat{x}} ( t ) = A \hat{x} ( t ) + Bu ( t ) + {L}_{g} ( y ( t ) - \hat{y} ( t ) ) \\ \hat{y} ( t ) = C \hat{x} ( t ) \\ r ( t ) = y ( t ) - \hat{y} ( t )\end{matrix} \qquad ( 27 )$$
where \hat{\dot{x}}(t) denotes a state estimation vector for residual generation, L_{g} denotes a gain value matrix of the attack residual generation model, and r(t) denotes a residual vector.

15. The method of claim 14, wherein the calculating is performed using a residual evaluation function shown in the following Equation (28):
$${R}_{i} ( t ) = LPF ( ⌈ {\vert {r}_{1} ( t ) \vert}^{2} , {\vert {r}_{2} ( t ) \vert}^{2} ⌉ ) \qquad ( 28 )$$
where LPF denotes a value derived through a low pass filter, and r(t)=[r₁,r₂]^{T} is defined by the following Equation (29):
$${r}_{1} ( t ) = ϕ - \hat{ϕ} , {r}_{2} ( t ) = \dot{ϕ} - \dot{\hat{ϕ}} . \qquad ( 29 )$$

16. The method of claim 15, wherein the determining comprises:
performing diagnosis based on a membership function that receives, as input, a residual and a residual differential value calculated based on a pre-designed residual threshold and a pre-designed residual differential threshold.
